(19) United States
(12) Patent Application Publication
(10) Pub. No.: US 2020/0394923 A1
(43) Pub. Date: Dec. 17, 2020

(54) VEHICLE TO VEHICLE NAVIGATION SYNCING SYSTEM

(71) Applicant: Toyota Motor Engineering & Manufacturing North America, Inc., Plano, TX (US)

(72) Inventors: Derek A. Thompson, Ypsilanti, MI (US); Derek L. Lewis, Monroe, MI (US); Douglas Bates, South Lyon, MI (US)

(21) Appl. No.: 16/439,290

(22) Filed: Jun. 12, 2019

(51) Int. Cl. G08G 1/00; G08G 1/0968; H04W 4/46

(52) U.S. Cl. CPC G08G 1/22; H04W 4/46; G08G 1/096816

(57) ABSTRACT

Methods and systems for synchronizing navigation destination between a plurality of vehicles. The system includes an input/output unit of a first vehicle configured to receive a destination from a user of the first vehicle. The system includes an ECU of the first vehicle configured to communicate the destination to all other vehicles in the plurality of vehicles. The system includes a transceiver of a second vehicle in the plurality of vehicles configured to receive the destination from the transceiver of the first vehicle. The system includes an input/output unit of the second vehicle configured to provide a prompt to a user of the second vehicle regarding the destination of the first vehicle and whether to accept or reject the destination. The system includes an ECU of the second vehicle configured to determine navigation directions to the destination when the user of the second vehicle accepts the destination.

### BACKGROUND

### 1. Field

This specification relates to a system and a method for synchronizing navigation across multiple vehicles.

### 2. Description of the Related Art

Drivers may use navigation systems to navigate from a current location to a destination. The navigation systems may provide a set of turn-by-turn directions for the driver to follow to get from the current location to the destination. In some situations, the driver may be driving alongside a group of other drivers. For example, a group of drivers may be driving to a concert or campsite. However, these drivers may not know exactly where the other drivers are located, as driving speeds and styles vary across drivers. Drivers may use mobile devices, such as smartphones to call or text the other drivers to coordinate locations and possible stops, but use of mobile devices while driving is dangerous, and in many jurisdictions, illegal. Thus, there is a need for improved syncing of navigation systems.

### SUMMARY

What is described is a system for synchronizing navigation destination between a plurality of vehicles. The system includes an input/output unit of a first vehicle configured to receive a destination from a user of the first vehicle. The system also includes an ECU of the first vehicle configured to communicate the destination to all other vehicles in the plurality of vehicles via a transceiver of the first vehicle. The system also includes a transceiver of a second vehicle in the plurality of vehicles configured to receive the destination from the transceiver of the first vehicle via a network. The system also includes an input/output unit of the second vehicle configured to provide a prompt to a user of the second vehicle regarding the destination of the first vehicle and whether to accept or reject the destination. The system also includes an ECU of the second vehicle configured to determine navigation directions to the destination when the user of the second vehicle accepts the destination via the input/output unit of the second vehicle.

Also described is a vehicle including a transceiver configured to receive a first destination from a transceiver of another vehicle via a network. The vehicle includes an input/output unit configured to provide a prompt to a user of the vehicle regarding the received first destination of the other vehicle and whether to accept or reject the first destination. The vehicle includes an ECU configured to determine navigation directions to the first destination when the user of the vehicle accepts the first destination via the input/output unit.

Also described is a method for synchronizing navigation destination between a plurality of vehicles. The method includes receiving, by an input/output unit of a first vehicle, a destination from a user of the first vehicle. The method also includes communicating, by an ECU of the first vehicle, the destination to all other vehicles in the plurality of vehicles via a transceiver of the first vehicle. The method also includes receiving, by a transceiver of a second vehicle in the plurality of vehicles, the destination from the transceiver of the first vehicle via a network. The method also includes providing, by an input/output unit of the second vehicle, a prompt to a user of the second vehicle regarding the destination of the first vehicle and whether to accept or reject the destination. The method also includes determining, by an ECU of the second vehicle, navigation directions to the destination when the user of the second vehicle accepts the destination via the input/output unit of the second vehicle.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 illustrates multiple vehicles and multiple routes to a destination, according to various embodiments of the invention.

FIG. 2 illustrates multiple vehicles using a common route to a destination, according to various embodiments of the invention.

FIG. 3 illustrates a vehicle of the multiple vehicles suggesting a stop along the route, according to various embodiments of the invention.

FIG. 4 illustrates a vehicle of the multiple vehicles stopping along the route, according to various embodiments of the invention.

FIG. 5 illustrates identification of vehicles along a route to a destination, according to various embodiments of the invention.

FIG. 6 illustrates a block diagram of the vehicle to vehicle navigation syncing system, according to various embodiments of the invention.

FIG. 7 illustrates a process of the vehicle to vehicle navigation syncing system, according to various embodiments of the invention.

### DETAILED DESCRIPTION

Disclosed herein are systems, vehicles, and methods for synchronizing navigation to a destination across multiple vehicles. The systems, vehicles, and methods described herein allow vehicles to join in groups (e.g., via a virtual lobby or by invitation from a vehicle) and the vehicles in the group can share information with each other, such as location and any suggestions, including route suggestions or stop suggestions. Each vehicle may choose to accept or reject the suggestions of other vehicles. When the suggestion is accepted, the vehicle's navigation is automatically updated. For example, when a first vehicle suggests making a stop along the way to the destination and the second vehicle accepts the suggestion, the second vehicle automatically updates the navigation route to incorporate the stop into the route to the destination.

Conventional systems do not allow for the shared communication of information between vehicles regarding routes to a common destination. Drivers may use mobile devices, such as smartphones to call or text the other drivers to coordinate locations and possible stops, but use of mobile devices while driving is dangerous, and in many jurisdictions, illegal. The systems, vehicles, and methods described herein improve safety as well as improve vehicle efficiency by having all of the vehicles in the synchronized group of vehicles aware of the location data and route data of the other vehicles.

As used herein, “driver” may refer to a human being driving the vehicle when the vehicle is a non-autonomous vehicle, and/or “driver” may also refer to one or more computer processors used to autonomously or semi-autonomously drive the vehicle. “User” may be used to refer to the driver or occupant of the vehicle when the vehicle is a non-autonomous vehicle, and “user” may also be used to refer to an occupant of the vehicle when the vehicle is an autonomous or semi-autonomous vehicle.

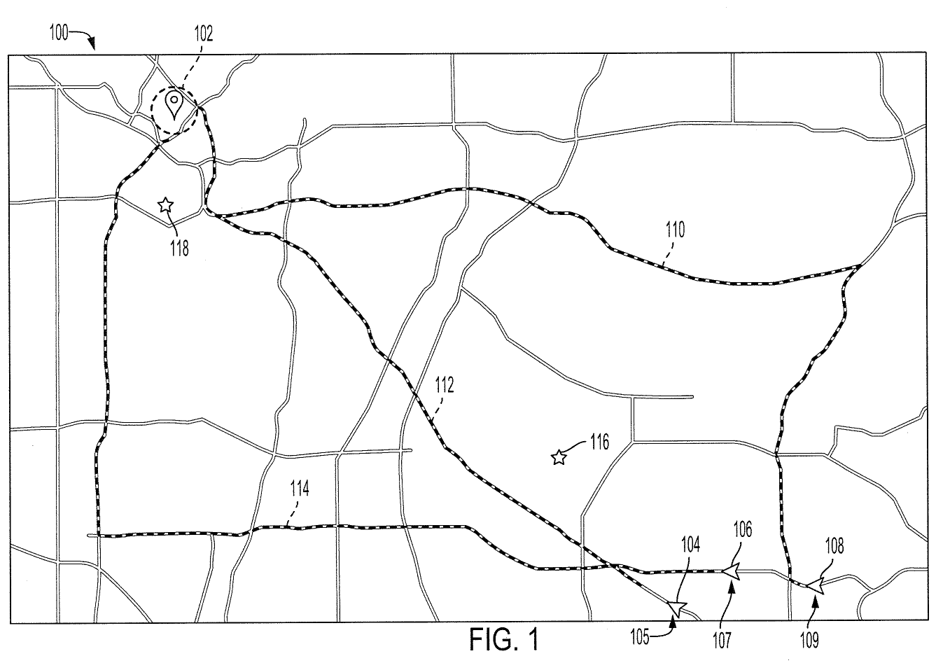

FIG. 1 illustrates a map 100 of a first vehicle 104 at a first location 105, a second vehicle 106 at a second location 107, and a third vehicle 108 at a third location 109. The first vehicle 104, the second vehicle 106, and the third vehicle 108 may each have navigation units or infotainment units. The first vehicle 104, the second vehicle 106, and the third vehicle 108 may also connect with each other via their respective navigation units or infotainment units. When the vehicles connect with each other, they may share navigation destinations, routes, exchange messages, or exchange other data, such as vehicle data or entertainment data (e.g., music playlists). Any number of vehicles may connect with each other in a group.

When a user of any vehicle from the group of connected vehicles enters a destination into the navigation unit or infotainment unit of the vehicle, the other vehicles may receive a notification in their respective vehicles. For example, when a user of the first vehicle 104 enters a destination of a baseball stadium 102 into the navigation unit of the first vehicle 104, the second vehicle 106 and the third vehicle 108 may receive a notification that the first vehicle 104 is travelling to a destination. The destination (e.g., baseball stadium 102) may be identified as a point of interest (e.g., “Baseball Stadium”) and/or by its respective address (e.g., “100 Team Way”). The notification received by the other vehicles in the group of vehicles may be a visual notification on a screen of the infotainment unit, heads-up display, or any other display in the passenger cabin of the respective other vehicles. The notification received by the other vehicles in the group of vehicles may be an audio notification from a in the passenger cabin of the respective other vehicles.

When the other vehicles in the group of vehicles (e.g., the second vehicle 106 and the third vehicle 108) receive the notification regarding the first vehicle 104 travelling to a destination of baseball stadium 102, the users of the other vehicles may accept or reject the destination. When the destination is accepted, the vehicle will automatically set a navigation destination to the destination identified by the first vehicle 102 (e.g., baseball stadium 102). When the destination is rejected (or not accepted), the vehicle will not set its navigation destination to the destination identified by the first vehicle 102.

For example, the second vehicle 106 may receive a notification that the first vehicle 104 is travelling to the baseball stadium 102. The user of the second vehicle 106 accepts the destination, and the navigation unit of the second vehicle 106 sets its destination to the baseball stadium 102. The third vehicle 108 may also receive a notification that the first vehicle 104 is travelling to the baseball stadium 102. The user of the third vehicle 108 accepts the destination, and the navigation unit of the third vehicle 108 sets its destination to the baseball stadium 102. Thus, the first vehicle 104, the second vehicle 106, and the third vehicle 108 have a common destination of the baseball stadium 102.

When the other vehicles have previously-entered destinations that they were travelling to prior to receiving the notification from the first vehicle, those previously-entered destinations may be replaced with the accepted common destination. For example, the second vehicle 106 may have had a previously-entered destination 116 it was travelling to and the third vehicle 108 may have had a previously-entered destination 118 it was travelling to, and those previously-entered destinations 116, 118 may be replaced with the common destination of the baseball stadium 102 when the second vehicle 106 and the third vehicle 108 accept the destination of the first vehicle 104.

The vehicles in the group of vehicles may collectively determine a route to take to the destination. In some embodiments, the user or driver of the vehicle that proposed the destination determines a route to take, and the other vehicles in the group of vehicles may propose alternate routes. For example, the user or driver of the first vehicle 104 may propose a first route 110 initially, but the user or driver of the second vehicle 106 may propose a second route 112 and the user or driver of the third vehicle 108 may propose a third route 114, or the second vehicle 106 and the third vehicle 108 may both propose use of the third route 114. A voting system may be initiated, or ultimate decision making of the route to take may be left to the driver or user of the initial vehicle (e.g., the first vehicle 104). In some embodiments, the vehicles in the group of vehicles may be free to take different routes to the destination, and each vehicle may provide the location and status of the other vehicles.

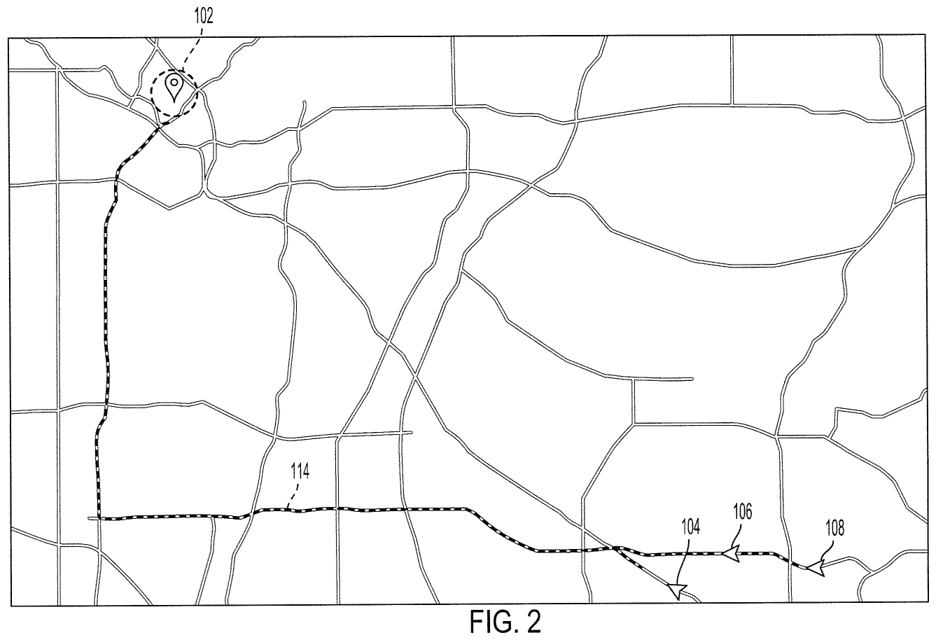

FIG. 2 illustrates the first vehicle 104, the second vehicle 106, and the third vehicle 108 all travelling to the common destination of the baseball stadium 102 via a route 114.

The navigation unit of any the vehicles may identify the current location of the other vehicles in the group of vehicles. For example, the navigation unit of the first vehicle 104 may provide an indication to the user of the first vehicle 104 the location of the second vehicle 106 and the location of the third vehicle 108. The locations of the other vehicles may be indicated on a map. The locations of the other vehicles may also be presented relative to the present vehicle. For example, the first vehicle 104 may provide an indication that the second vehicle 106 is 4 miles northeast of the first vehicle 104 and the third vehicle is 10 miles east of the first vehicle 104.

Route related information of the other vehicles in the group of vehicles may be provided by the present vehicle, such as the estimated time to arrival, the estimated distance to the destination, or the estimated time remaining to destination. For example, the first vehicle 104 may provide an indication that the second vehicle 106 will arrive at the destination at 5:57 PM, the second vehicle 106 is 40 miles away from the destination, and/or that the second vehicle 106 will arrive at the destination in 55 minutes. The first vehicle 104 may also provide an indication that the third vehicle 108 will arrive at the destination at 6:07 PM, the third vehicle 108 is 48 miles away from the destination, and/or that the third vehicle 108 will arrive at the destination in 1 hour and 5 minutes.

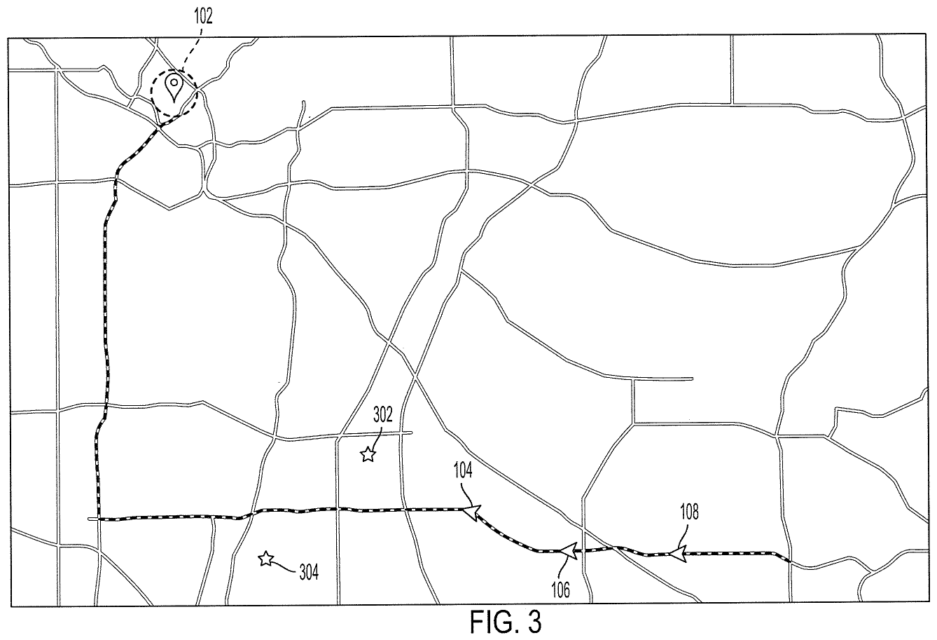

FIG. 3 illustrates a vehicle from the group of vehicles suggesting a stop along the route. In some situations, a user of a vehicle may desire to make a stop along the way to the destination, as the user may be tired or hungry, or the vehicle may be running low on gas or electricity. For example, the user of the second vehicle 106 may propose making a stop at a first stop location 302 to get something to eat. The user of the second vehicle 106 may identify the first stop location 302 in the navigation unit of the second vehicle 106. A notification may appear on the navigation units of the other vehicles (e.g., first vehicle 104 and the third vehicle 108) indicating that the second vehicle 106 has proposed making a stop at the first stop location 302.

The users of the other vehicles may receive a prompt as to whether the first stop location 302 should be incorporated into the route. For example, the user of the first vehicle 104 and the user of the third vehicle 108 may accept the incorporation of the first stop location 302 into the route, and the navigation units of the first vehicle 104, the second vehicle 106, and the third vehicle 108 may all provide navigation directions to the first stop location 302 and then to the destination 102. When the other vehicle does not incorporate the stop into the route, the other vehicle may maintain the route to the destination. For example, if the user of the first vehicle 104 does not want to make a stop, the first vehicle 104 may continue on to the destination 102. In some embodiments, the proposed stop may only be incorporated into the route if all of the vehicles in the group accept the stop.

Any of the other vehicles may also propose an alternate stop in response to receiving the proposed stop. For example, if the second vehicle 106 proposes stopping at the first stop location 302, the third vehicle 108 may propose an alternate stop—the second stop location 304. The proposed alternate location may be identified by the user of the third vehicle 108 using the navigation unit of the third vehicle 108 and presented to the other vehicles (e.g., the first vehicle 104 and the second vehicle 106) as described herein. The users of the other vehicles may accept or reject the proposal of the alternate stop.

For example, the second vehicle 106 may propose a first stop location 302 and the third vehicle 108 may propose an alternate stop—the second stop location 304. The user of the first vehicle 104 may choose between: accepting the first stop location 302, accepting the second stop location 304, or denying both and maintaining navigation to the destination 102. The user of the second vehicle 106 may choose between: accepting the second stop location 304 or maintaining navigation to the first stop location 302. The user of the second vehicle 106 may also have the choice of cancelling the navigation to the first stop location 302 and proceeding to the destination 102. The user of the third vehicle 108 may choose between: maintaining navigation to the second stop location 304 or cancelling the navigation to the second stop location 304 and proceeding to the destination 102. The user of the third vehicle 108 may also have the choice of cancelling the navigation to the second stop location 304 and navigating to the first stop location 302 instead.

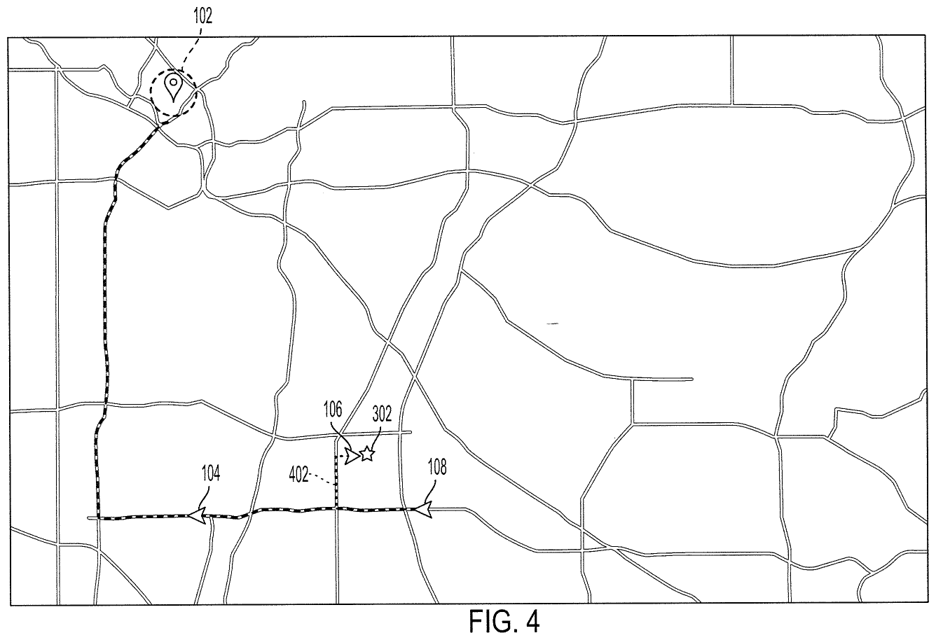

FIG. 4 illustrates the second vehicle 106 at the first stop location 302. The user of the first vehicle 104 did not accept the proposal to stop at the first stop location 302 and is proceeding along the route 114 to the destination 102. The user of the third vehicle 108 also did not accept the proposal to stop at the first stop location 302 and is proceeding along the route 114 to the destination.

In some embodiments, there may be a designated leader vehicle from the group of vehicles. The leader vehicle may make the final decisions on destinations, routes, and stops, with the following vehicles providing proposals for the leader vehicle to accept or reject. The leader vehicle may not necessarily be physically closer to the destination than the following vehicles.

For example, the first vehicle 104 may be the leader of the group of vehicles shown in FIGS. 1-4. The first vehicle 104 may determine the route to take to the destination 102. The other vehicles (e.g., the second vehicle 106 and the third vehicle 108) may make recommendations of which route to take, but ultimately, the first vehicle 104 determines which route to take to the destination 102, and the other vehicles are provided the chosen route. The first vehicle 104 may also determine whether any stops are made. Again, the other vehicles may made recommendations of stop locations, but ultimately, the first vehicle determines where to make any stops along the way to the destination 102.

The leader vehicle may also control other aspects of the collective trip, including a shared playlist of music. The user of the leader vehicle may identify a playlist of music or a radio station on the infotainment unit of the leader vehicle, and the identified playlist of music or the radio station is provided to the following vehicles.

In these embodiments where there is a leader vehicle and following vehicles, the designation of leader vehicle may be passed from the leader vehicle to one of the following vehicles. For example, the first vehicle 104 may initially be the leader vehicle, but the first vehicle 104 may pass the designation of leader vehicle to the second vehicle 106 or the third vehicle 108. In some embodiments, the second vehicle 106 or the third vehicle 108 must accept the designation as new leader vehicle, and in other embodiments, the current leader vehicle may unilaterally appoint a following vehicle as being the new leader vehicle.

Creation of the group of vehicles may be performed in various ways. A particular vehicle may have a list of contact vehicles that may be eligible to join the particular vehicle in a group of vehicles. These contact vehicles may perform steps to give consent to being included in the particular vehicle's list. For example, to add a second vehicle to a first vehicle's list of contact vehicles, the user of the second vehicle may provide a code unique to the second vehicle to the user of the first vehicle.

The particular vehicle may be able to choose from the list of contact vehicles which vehicles to include in the group of vehicles to collectively travel together with. The contact vehicles may be prompted to join the particular vehicle's group of vehicles, and each contact vehicle may accept or reject the request.

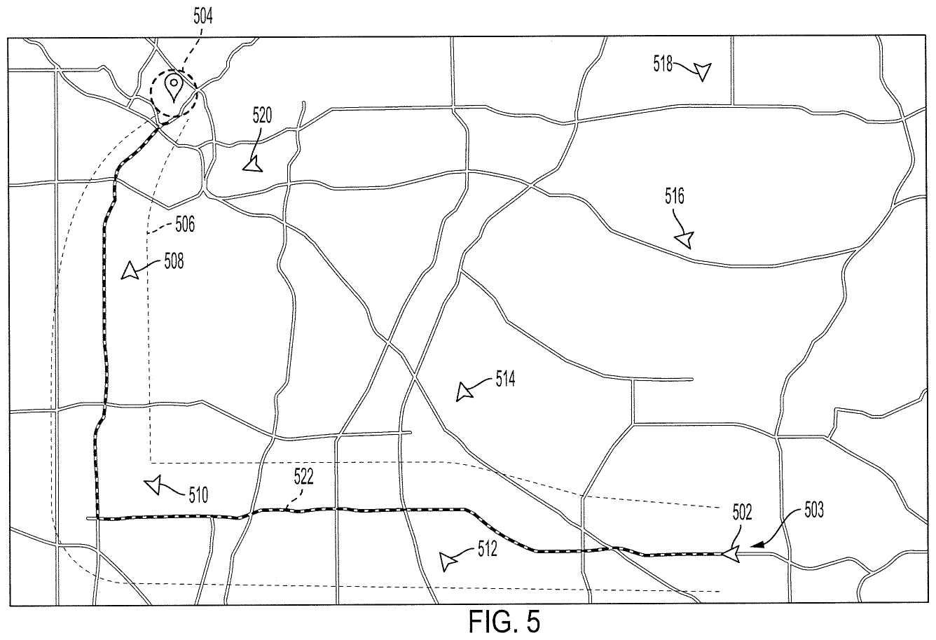

The system may also automatically recommend one or more contact vehicles that may be interested in joining a group of vehicles to a destination. FIG. 5 illustrates a first vehicle 502. The user of the first vehicle 502 enters a destination 504 into the navigation unit of the first vehicle 502. The user of the first vehicle 502 may determine a route 522 to take from the current location 503 of the first vehicle 502 to the destination 504.

The first vehicle 502 may have a list of contact vehicles (e.g., second vehicle 508, third vehicle 510, fourth vehicle 512, fifth vehicle 514, sixth vehicle 516, seventh vehicle 518, and eighth vehicle 520). The system may automatically identify which vehicles in the list of contact vehicles are within a predetermined range of the route 522 to the destination 504. The predetermined range may be set by the user of the first vehicle 502 or by the vehicle manufacturer, and the predetermined range may be changed at any time. The predetermined range may be used to determine a boundary 506 along the route 522. The system may automatically identify any vehicles in the list of contact vehicles that are within the boundary 506 (e.g., the second vehicle 508, the third vehicle 510, and the fourth vehicle 512). In some embodiments, the system automatically communicates an indication to these vehicles that the first vehicle 502 is travelling to the destination 504, and prompting these contact vehicles as to whether they would like to join a group with the first vehicle 502 and travel to the destination 504. In some embodiments, the system provides a list of the contact vehicles that are within the boundary 506 to the user of the first vehicle 502, and the user of the first vehicle 502 selects which contact vehicles to communicate with. The selected contact vehicles receive an indication that the first vehicle 502 is travelling to the destination 504 and the selected contact vehicles receive a prompt as to whether they would like to join a group with the first vehicle 502.

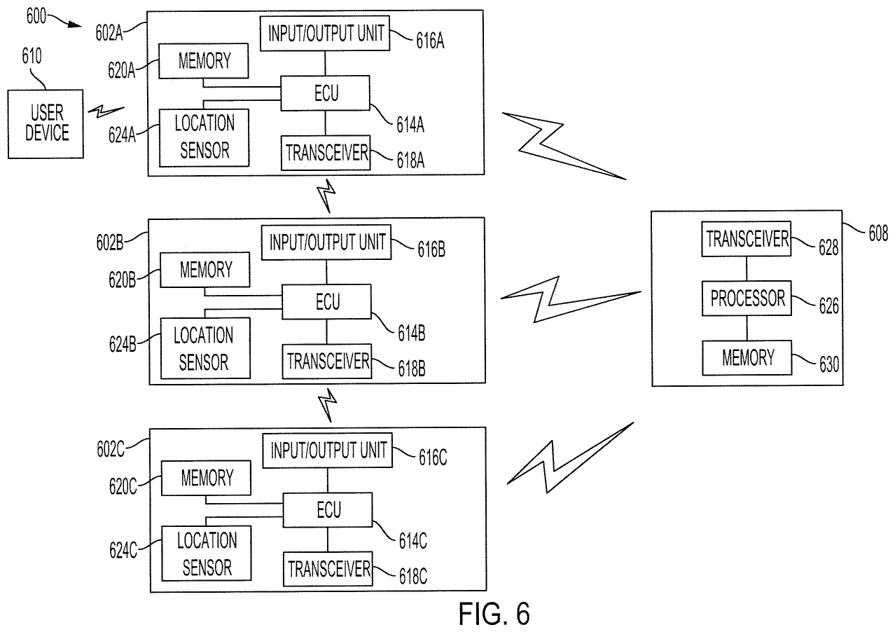

FIG. 6 illustrates a block diagram of the system 600. The system 600 includes a first vehicle 602A, a second vehicle 602B, and a third vehicle 602C, each similar to the vehicles described in FIGS. 1-5. Components of the system having a letter suffix may be referred to individually or as a group by the reference number without the letter suffix (e.g., vehicle 602 may refer to each of the vehicles 602A, 602B, or 602C or may refer to the vehicles 602A, 602B, and 602C collectively).

The vehicle 602 may have an automatic or manual transmission. The vehicle 602 is a conveyance capable of transporting a person, an object, or a permanently or temporarily affixed apparatus. The vehicle 602 may be a self-propelled wheeled conveyance, such as a car, a sports utility vehicle, a truck, a bus, a van or other motor or battery driven vehicle. For example, the vehicle 602 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation. The vehicle 602 may be a semi-autonomous vehicle or an autonomous vehicle. That is, the vehicle 602 may be self-maneuvering and navigate without human input. An autonomous vehicle may use one or more sensors and/or a navigation unit to drive autonomously.

The first vehicle 602A includes an electronic control unit (ECU) 614A, an input/output unit 616A, a transceiver 618A, a memory 620A, a display 622A, and a location sensor 624A. The second vehicle 602B includes an ECU 614B, an input/output unit 616B, a transceiver 618B, a memory 620B, a display 622B, and a location sensor 624B. The third vehicle 602C includes an ECU 614C, an input/output unit 616C, a transceiver 618C, a memory 620C, a display 622C, and a location sensor 624C.

Each ECU 614 may be one or more ECUs, appropriately programmed, to control one or more operations of the vehicle. The one or more ECUs 614 may be implemented as a single ECU or in multiple ECUs. The ECU 614 may be electrically coupled to some or all of the components of the vehicle. In some embodiments, the ECU 614 is a central ECU configured to control one or more operations of the entire vehicle. In some embodiments, the ECU 614 is multiple ECUs located within the vehicle and each configured to control one or more local operations of the vehicle. In some embodiments, the ECU 614 is one or more computer processors or controllers configured to execute instructions stored in a non-transitory memory 620.

The vehicles 602 may be coupled to a network. The network, such as a local area network (LAN), a wide area network (WAN), a cellular network, a digital short-range communication (DSRC), the Internet, or a combination thereof, connects the vehicles 602 to a remote data server 608.

The transceiver 618 may include a communication port or channel, such as one or more of a Wi-Fi unit, a Bluetooth® unit, a Radio Frequency Identification (RFID) tag or reader, a DSRC unit, or a cellular network unit for accessing a cellular network (such as 3G or 4G). The transceiver 618 may transmit data to and receive data from devices and systems not directly connected to the vehicle. For example, the ECU 614 may communicate with the remote data server 608. Furthermore, the transceiver 618 may access the network, to which the remote data server 608 is also connected. The vehicles 602 may communicate with each other directly or via a network.

The location sensor 624 is connected to the ECU 614 and configured to determine location data. The location sensor may be a GPS unit or any other global location detection device. The ECU 614 may use the location data along with the map data stored in the memory 620 to determine a location of the vehicle. In other embodiments, the location sensor 624 has access to the map data and may determine the location of the vehicle and provide the location of the vehicle to the ECU 614. In some embodiments, the location data of the vehicle may be received from another device (e.g., mobile device, another vehicle) via the transceiver 618.

The memory 620 is connected to the ECU 614 and may be connected to any other component of the vehicle. The memory 620 is configured to store any data described herein, such as the map data, the location data, and any data received from the remote data server 608 via the transceiver 618.

The input/output unit 616 may be a touchscreen display or a display screen and an input device, such as a keyboard, microphone, or buttons. The input/output unit 616 may be a touchscreen of an infotainment unit of the vehicle 602, a heads-up display, or a combination of a display screen of the infotainment unit and one or more buttons or knobs used to interact with the infotainment unit. The ECU 614 may be configured to render a graphical user interface to facilitate displaying of group vehicle information, such as the locations of the other vehicles in the group of vehicles and/or the list of contact vehicles as described herein. The graphical user interface may also facilitate the communication of suggestions (e.g., routes or stops) from one vehicle to the group of vehicles.

As used herein, “navigation unit” may refer to the ECU 614, the location sensor 624, the input/output unit 616 and the display 622 working in concert to provide location data to the user of the vehicle 602 as well as providing navigation directions from a current location to one or more destinations.

A user device 610 may be paired to any of the vehicles 602. The user device 610 may be a mobile device (e.g., smartphone, laptop, tablet) and may be used to provide entertainment data to the infotainment unit of the vehicle 602, such as music. 100521 Each of the vehicles 602 may provide location data to the remote data server 608 using their transceivers 618 and the transceiver 628 of the remote data server 608. The remote data server 608 may store lists of the contact vehicles associated with each vehicle 602 in memory 630. The processor 626 of the remote data server 608 may determine the location data of the vehicles in a particular list of contact vehicles and may send the location data to the appropriate vehicle. For example, if the first vehicle 602A has the second vehicle 602B and the third vehicle 602C in its list of contact vehicles, the processor 626 of the remote data server 608 provides the location data of the second vehicle 602B and the third vehicle 602C to the first vehicle 602A. If the second vehicle 602B only has the first vehicle 602A in its list of contact vehicles, the processor 626 of the remote data server 608 provides the location data of the first vehicle 602A to the second vehicle 602B. In some embodiments, when two vehicles are not in each other's lists of contact vehicles, they may not be able to see each other's locations, but when they are in a group of vehicles travelling to a common destination, they may then be able to see each other's locations.

The processor 626 of the remote data server 608 may also automatically determine which vehicles are within the predetermined range of a current route of a vehicle, as described and illustrated in FIG. 5. The processor 626 may determine which vehicles are in the boundary along the route to the destination, and the processor 626 may automatically communicate the location data of these vehicles in the boundary to the subject vehicle (e.g., the first vehicle 502). When the system automatically invites any vehicles in the boundary to a group including the subject vehicle, the processor 626 automatically communicates the invitation to the other vehicles. When the system uses the user input from the subject vehicle to determine which vehicles within the boundary to invite, the processor 626 communicates the invitation to the other vehicles based on an identification from the subject vehicle.

While only three vehicles 602 are shown, any number of vehicles may be used. Likewise, while only one remote data server 608 is shown, any number of remote data servers in communication with each other may be used.

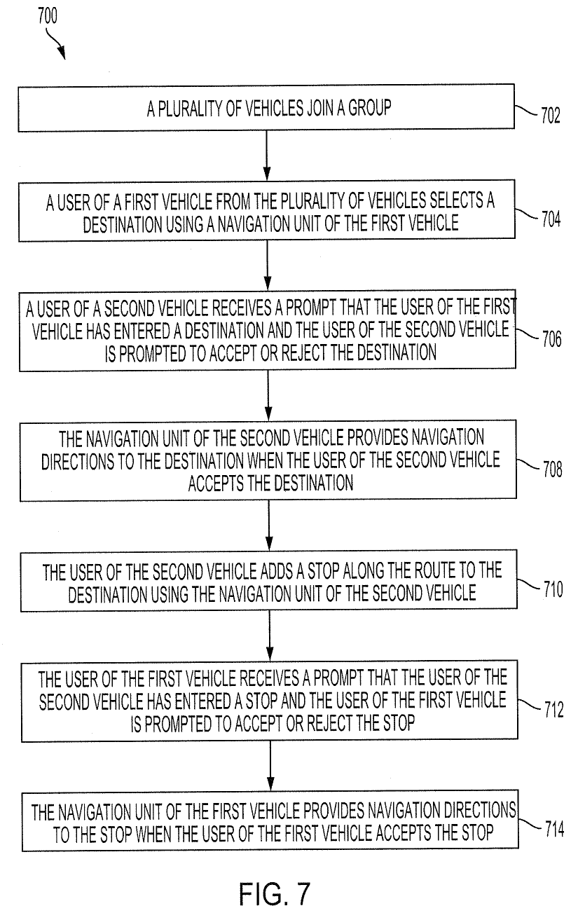

FIG. 7 illustrates a process 700 performed by the system described herein. A plurality of vehicles (e.g., vehicles 104-108, vehicles 602) join a group (step 702). The group may join via a virtual lobby of vehicles that have been previously identified to each other. The group may also join together when a single vehicle from the plurality of vehicles invites the other vehicles to join the group.

A user of a first vehicle from the plurality of vehicles selects a destination (e.g., destination 102) using a navigation unit of the first vehicle (step 704). More specifically, the user of the first vehicle may input a destination using an input/output unit (e.g., input/output unit 616). The destination may be sent to the plurality of vehicles. An ECU (e.g., ECU 614) of the first vehicle may use a transceiver (e.g., transceiver 618) of the first vehicle to send the destination to the plurality of vehicles. The plurality of vehicles may receive the destination via respective transceivers. The communication between vehicles may occur directly or via a network, such as the Internet.

While step 704 is shown as occurring after step 702, in some embodiments, step 704 may happen first, and the user of the first vehicle may identify the other vehicles to join the group.

A user of a second vehicle receives a prompt that the user of the first vehicle has entered a destination and the user of the second vehicle is prompted to accept or reject the destination (step 706). The prompt may be provided to the user of the second vehicle via an input/output unit of the second vehicle. The user of the second vehicle may use the input/output unit to accept the destination or reject the destination. For example, when the input/output unit is a touchscreen device, the touchscreen device may present two icons—one to accept and one to reject—the destination, and the user of the second vehicle may make a selection by touching one of the two icons.

The navigation unit of the second vehicle provides navigation directions to the destination when the user of the second vehicle accepts the destination (step 708). In particular, the ECU of the second vehicle may determine navigation directions to the destination using location data from a location sensor (e.g., location sensor 624) and map data stored in memory (e.g., memory 620).

The user of the second vehicle adds a stop along the route to the destination using the navigation unit of the second vehicle (step 710). In particular, the user of the second vehicle may use the input/output unit of the second vehicle to identify the stop. The ECU of the second vehicle may use its transceiver to communicate the stop to the other vehicles, either directly or via a network. The respective transceivers of the other vehicles receive the suggested stop.

The user of the first vehicle receives a prompt that the user of the second vehicle has entered a stop and the user of the first vehicle is prompted to accept or reject the stop (step 712). The prompt may be provided to the user of the first vehicle via the input/output unit of the first vehicle. The user of the first vehicle may use the input/output unit to accept the stop or reject the stop. For example, when the input/output unit is a touchscreen device, the touchscreen device may present two icons—one to accept and one to reject—the stop, and the user of the first vehicle may make a selection by touching one of the two icons. While the first vehicle is discussed in step 712, the user of every other vehicle in the group of vehicles performs the same step.

The navigation unit of the first vehicle provides navigation directions to the stop when the user of the first vehicle accepts the stop (step 708). In particular, the ECU of the first vehicle may determine navigation directions to the stop using location data from a location sensor and map data stored in memory. Again, while the first vehicle is discussed in step 714, the user of every other vehicle in the group of vehicles performs the same step. In some embodiments, the navigation directions may be updated to include the stop in the route that ultimately leads to the destination.

In some embodiments, the navigation unit of the second vehicle incorporates the stop into the navigation directions regardless of whether any other vehicles have accepted the stop. In other embodiments, the navigation unit of the second vehicle only incorporates the stop into the navigation directions if all of the other vehicles have accepted the stop or if a majority of the other vehicles have accepted the stop.

Once the vehicles have reached the destination, the group synchronized travelling session may be over, and a new session may be started in a process similar to those described herein.

While the systems and methods described herein have been discussed with respect to vehicles, the systems and methods described herein may also be applied to mobile devices. For example, instead of a plurality of vehicles in the group, the systems and methods disclosed herein may use a plurality of mobile devices of occupants in a vehicle. The mobile devices may include similar components as a vehicle (e.g., a control unit, a location sensor, an input/output unit, a transceiver, and memory) and may perform all of the functions described herein that a vehicle does.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for synchronizing navigation destination between a plurality of vehicles, the system comprising:
an input/output unit of a first vehicle configured to receive a destination from a user of the first vehicle;
an electronic control unit (ECU) of the first vehicle configured to communicate the destination to all other vehicles in the plurality of vehicles via a transceiver of the first vehicle;
a transceiver of a second vehicle in the plurality of vehicles configured to receive the destination from the transceiver of the first vehicle via a network;
an input/output unit of the second vehicle configured to provide a prompt to a user of the second vehicle regarding the destination of the first vehicle and whether to accept or reject the destination; and
an ECU of the second vehicle configured to determine navigation directions to the destination when the user of the second vehicle accepts the destination via the input/output unit of the second vehicle.

2. The system of claim 1, wherein the input/output unit of the second vehicle is configured to receive a stop location from the user of the second vehicle,
wherein the ECU of the second vehicle is configured to communicate the stop location to all other vehicles in the plurality of vehicles via the second transceiver,
wherein the transceiver of the first vehicle is configured to receive the stop location from the transceiver of the second vehicle via the network,
wherein the input/output unit of the first vehicle is further configured to provide a prompt to the user of the first vehicle regarding the stop location and whether to accept or reject the stop location, and
wherein the ECU of the first vehicle is further configured to update navigation directions to the destination to include the stop location when the user of the first vehicle accepts the stop location via the input/output unit of the first vehicle.

3. The system of claim 2, wherein the ECU of the first vehicle is further configured to maintain navigation to the destination when the user of the first vehicle rejects the stop location via the input/output unit of the first vehicle.

4. The system of claim 1, wherein the input/output unit of the first vehicle provides a list of contact vehicles and respective location information for each vehicle in the list of contact vehicles.

5. The system of claim 4, wherein the user of the first vehicle selects vehicles from the list of contact vehicles via the input/output unit to include in the plurality of vehicles.

6. The system of claim 1, wherein the plurality of vehicles is automatically determined by a processor of a remote data server based on the destination, a route of the first vehicle to the destination, and respective location data of vehicles in a list of contact vehicles associated with the user of the first vehicle.

7. The system of claim 1, wherein the input/output unit of the first vehicle, the ECU of the first vehicle, and the transceiver of the first vehicle are included in a first mobile device located in the first vehicle, and wherein the input/output unit of the second vehicle, the ECU of the second vehicle, and the transceiver of the second vehicle are included in a second mobile device located in the second vehicle.

8. A vehicle comprising:
a transceiver configured to receive a first destination from a transceiver of another vehicle via a network;
an input/output unit configured to provide a prompt to a user of the vehicle regarding the received first destination of the other vehicle and whether to accept or reject the first destination; and
an electronic control unit (ECU) configured to determine navigation directions to the first destination when the user of the vehicle accepts the first destination via the input/output unit.

9. The vehicle of claim 8, wherein the wherein the transceiver is configured to receive a stop location from the transceiver of the other vehicle,
wherein the input/output unit is further configured to provide a prompt to the user of the vehicle regarding the stop location and whether to accept or reject the stop location, and
wherein the ECU is further configured to update navigation directions to the destination to include the stop location when the user of the vehicle accepts the stop location via the input/output unit.

10. The vehicle of claim 9, wherein the ECU is further configured to maintain navigation to the destination when the user of the vehicle rejects the stop location via the input/output unit.

11. The vehicle of claim 8, wherein the input/output unit is configured to receive a stop location from the user, and wherein the ECU is configured to communicate, via the transceiver, the stop location to one or more group vehicles including the other vehicle.

12. The vehicle of claim 11, wherein the ECU is further configured to update navigation directions to the destination to include the stop location.

13. The vehicle of claim 11, wherein the transceiver is further configured to receive one or more respective indications from the transceivers of the one or more group vehicles regarding whether the respective users of the one or more group vehicles accepted or rejected the stop location, and
wherein the ECU is further configured to update navigation directions to the destination to include the stop location when all of the one or more group vehicles accepted the stop location.

14. The vehicle of claim 11, wherein the transceiver is further configured to receive one or more respective indications from the transceivers of the one or more group vehicles regarding whether the respective users of the one or more group vehicles accepted or rejected the stop location, and
wherein the ECU is further configured to update navigation directions to the destination to include the stop location when a majority of the one or more group vehicles accepted the stop location.

15. A method for synchronizing navigation destination between a plurality of vehicles, the method comprising:
receiving, by an input/output unit of a first vehicle, a destination from a user of the first vehicle;
communicating, by an electronic control unit (ECU) of the first vehicle, the destination to all other vehicles in the plurality of vehicles via a transceiver of the first vehicle;
receiving, by a transceiver of a second vehicle in the plurality of vehicles, the destination from the transceiver of the first vehicle via a network;
providing, by an input/output unit of the second vehicle, a prompt to a user of the second vehicle regarding the destination of the first vehicle and whether to accept or reject the destination; and
determining, by an ECU of the second vehicle, navigation directions to the destination when the user of the second vehicle accepts the destination via the input/output unit of the second vehicle.

16. The method of claim 15, further comprising:
receiving, by the input/output unit of the second vehicle, a stop location from the user of the second vehicle;
communicating, by the ECU of the second vehicle, the stop location to all other vehicles in the plurality of vehicles via the second transceiver;
receiving, by the transceiver of the first vehicle, the stop location from the transceiver of the second vehicle via the network;
providing, by the input/output unit of the first vehicle, a prompt to the user of the first vehicle regarding the stop location and whether to accept or reject the stop location; and
updating, by the ECU of the first vehicle, the navigation directions to the destination to include the stop location when the user of the first vehicle accepts the stop location via the input/output unit of the first vehicle.

17. The method of claim 15, further comprising providing, by the input/output unit of the first vehicle, a list of contact vehicles and respective location information for each vehicle in the list of contact vehicles.

18. The method of claim 17, further comprising -receiving, from the user of the first vehicle via the input/output unit, a selection of vehicles from the list of contact vehicles to include in the plurality of vehicles.

19. The method of claim 15, further comprising automatically identifying, by a processor of a remote data server, the plurality of vehicles based on the destination, a route of the first vehicle to the destination, and respective location data of vehicles in a list of contact vehicles associated with the user of the first vehicle.

20. The method of claim 15, further comprising joining, by respective users of the plurality of vehicles via respective input/output units, a group to travel to the destination together using a virtual lobby.
